(19) United States
(12) Patent Application Publication
(10) Pub. No.: US 2014/0081777 A1
(43) Pub. Date: Mar. 20, 2014

(54) SYSTEMS AND METHODS FOR INTERACTING WITH A DEVICE

(71) Applicant: salesforce.com inc., San Francisco, CA (US)

(72) Inventors: Alex Mastrodonato, San Francisco, CA (US); Kevin Wu, San Francisco, CA (US); Helder Rocha, San Francisco, CA (US)

(73) Assignee: salesforce.com inc., San Francisco, CA (US)

(21) Appl. No.: 14/016,023

(22) Filed: Aug. 30, 2013

Related U.S. Application Data
(60) Provisional application No. 61/703,151, filed on Sep. 19, 2012.

(51) Int. Cl. G06Q 50/12; G06Q 30/06

(52) U.S. Cl. CPC G06Q 50/12; G06Q 30/0621
USPC 705/15

(57) ABSTRACT

The technology disclosed relates to improving sales of beverages by allowing users to create virtual beverage formulations across graphical user-interfaces. These user-customized beverage formulations can be interpreted by beverage dispensing machines that can transform them into real-word beverages. In particular, it relates to creating beverage identity tokens that hold user-customized beverage formulations. These beverage identity tokens can cause beverage dispensing machines to dispense real-world beverage mixes made up of the ingredient beverage flavors specified by the user in the virtual beverage formulations.

### RELATED APPLICATION

This application claims the benefit of U.S. Provisional Patent Application No. 61/703,151, entitled, “Systems And Methods For Interacting With A Device,” filed on 19 Sep. 2012. The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

The technology disclosed relates to improving sales of beverages by allowing users to create virtual beverage formulations across graphical user-interfaces. These user-customized beverage formulations can be interpreted by beverage dispensing machines that can transform them into real-word beverages. In particular, it relates to creating beverage identity tokens that hold user-customized beverage formulations. These beverage identity tokens can cause beverage dispensing machines to dispense real-world beverage mixes made up of the ingredient beverage flavors specified by the user in the virtual beverage formulations.

With growing wide-spread use of mobile technology, beverage vendors are allocating huge amounts of their marketing budgets to e-Marketing focused on mobile based applications. Moreover, the revolutionary arrival of multi-flavor drink dispensers such as Coke Freestyle and Pepsi Fusion has made the need of giving consumers the ability to electronically create their own custom beverages on various user devices imperative. Finally, the beverage vendors desire to engage the users on various social websites but until now there engagement campaigns are restricted to extra-beverage elements such as trivia about the product, gift coupons, etc.

Accordingly, it is desirable to provide systems and methods that offer an interactive beverage formulation platform. This platform can substantially increase consumer interest in beverage products and improve user engagement beverage campaigns, thus improving the sales of beverages.

An opportunity arises to create custom beverage formulations based on user preferences and further dispense the corresponding beverage from a dispensing machine. Improved user experience and engagement and higher customer satisfaction and retention may result.

### SUMMARY

The technology disclosed relates to improving sales of beverages by allowing users to create virtual beverage formulations across graphical user-interfaces. These user-customized beverage formulations can be interpreted by beverage dispensing machines that can transform them into real-word beverages. In particular, it relates to creating beverage identity tokens that hold user-customized beverage formulations. These beverage identity tokens can cause beverage dispensing machines to dispense real-world beverage mixes made up of the ingredient beverage flavors specified by the user in the virtual beverage formulations.

Other aspects and advantages of the present invention can be seen on review of the drawings, the detailed description and the claims, which follow.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1A illustrates one implementation of a graphical user-interface for creating a beverage formulation.

FIG. 1B shows another implementation of a graphical user-interface for creating a beverage formulation.

FIG. 1C illustrates another implementation of a graphical user-interface for creating a beverage formulation.

FIG. 1D shows another implementation of a graphical user-interface for creating a beverage formulation.

FIG. 2 shows one implementation of a beverage formulation environment.

FIG. 3 illustrates one implementation of a beverage formulation schema.

FIG. 4 is a flow chart of one implementation of beverage formulation.

FIG. 5 is a flow chart of one implementation of location-based beverage formulation.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to improving sales of beverages by allowing users to create customized beverage formulations. In particular, it relates to receiving a user selection of a custom beverage or formulation that mixes two or more beverages and generating a beverage identity token of the user-customized beverage or formulation that can be processed by a beverage dispensing machine. The technology disclosed can further send the beverage identity token to the beverage dispensing machine and cause it to dispense the corresponding beverage mix.

In some implementations, the technology disclosed can use an optical interface such as one-dimensional (1D) barcode or two-dimensional (2D) barcode to send the beverage identity token to the beverage dispensing machine. Alternatively, it can use a radio frequency (RF) signals via Bluetooth, radio frequency identifier (RFID) or near field communication technology for the token transfer.

The technology disclosed can share this beverage identity token with other users in social networks of a first user who formulates a beverage mix. For instance, when the first user creates a customized beverage formulation, the technology disclosed can post this beverage formulation in the social feed of first user's social profile. Other users in the social network of first user can then access the beverage formulation to dispense the same beverage as the one formulated by the first user.

In some implementations, the technology disclosed can calculate a device's location and automatically create a physical proximity event that represents likely proximity between the device and a beverage dispensing machine when the device approaches the beverage dispensing machine.

Upon registering a physical proximity event, the technology disclosed can automatically generate a preferred mix list of beverage formulations for user selection based on user preferences. It can then dispense the corresponding beverage from the beverage dispensing machine.

The technology disclosed relates to creating beverage formulations for use in a computer-implemented system. The described subject matter can be implemented in the context of any computer-implemented system, such as a software-based system, a database system, a multi-tenant environment, or the like. Moreover, the described subject matter can be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

### User-Interface

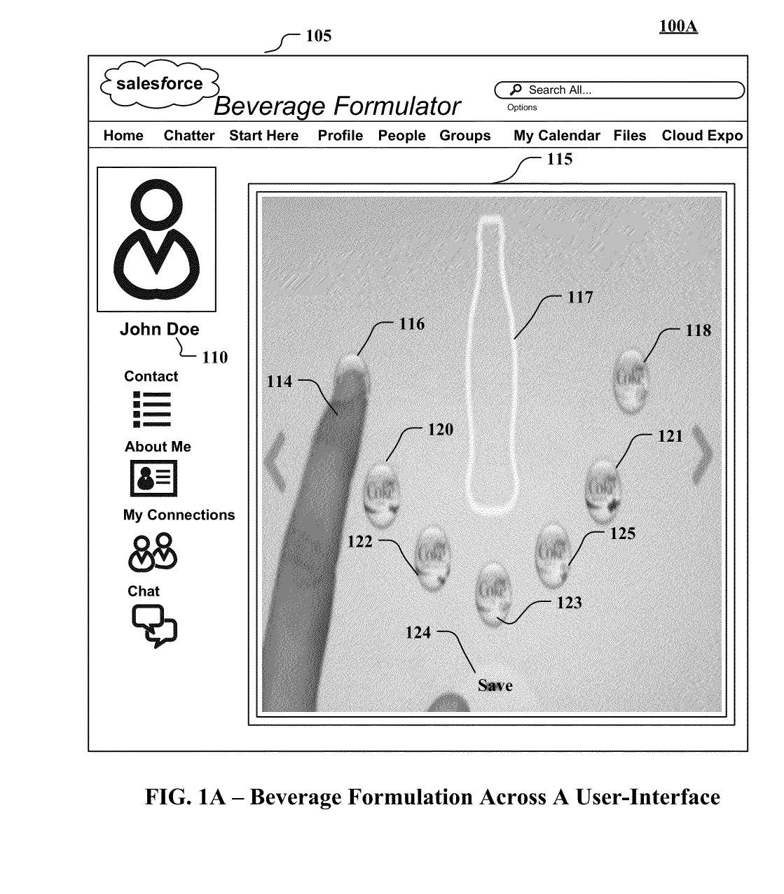

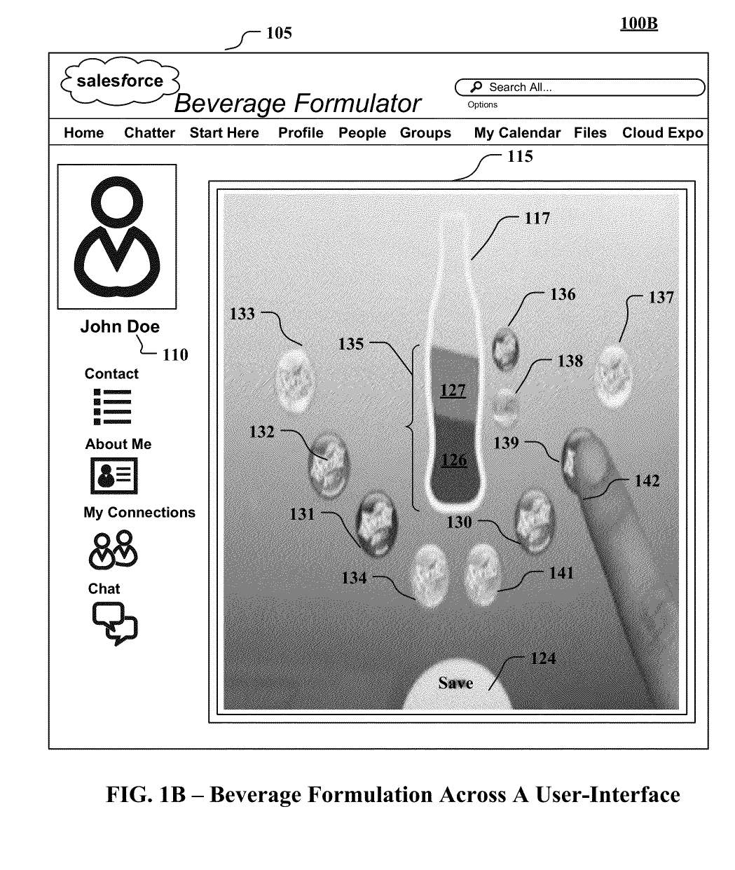

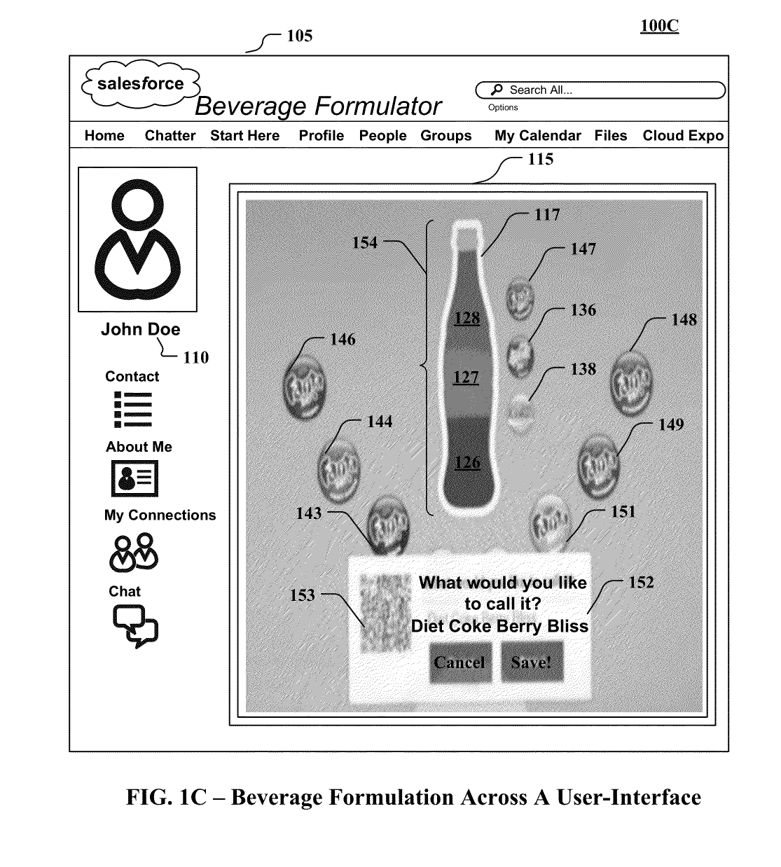

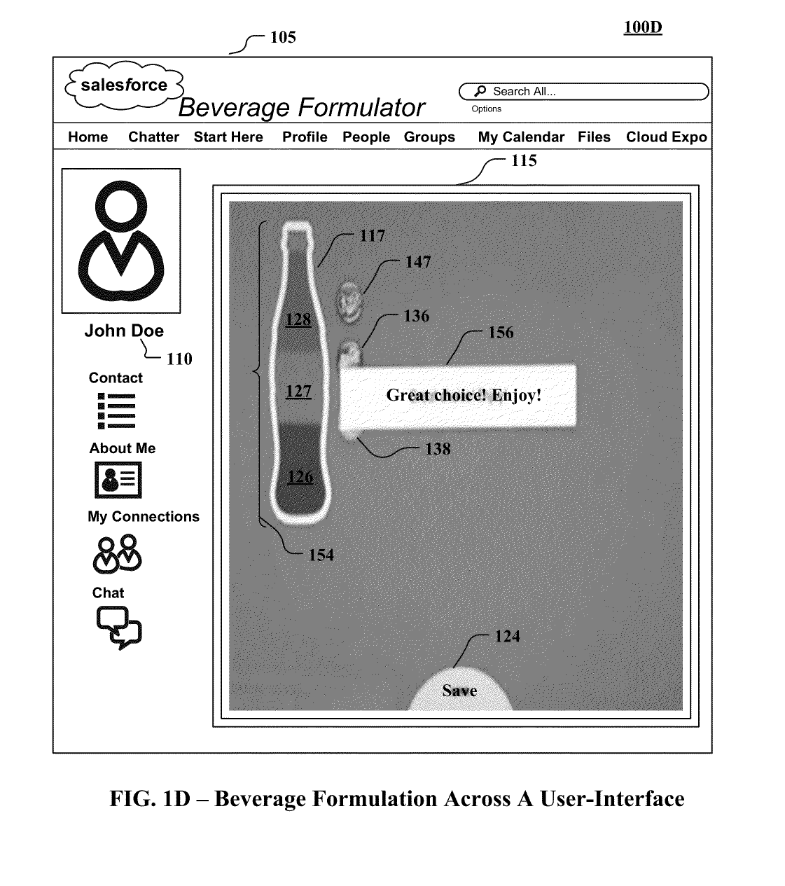

FIG. 1A illustrates one implementation of a graphical user-interface 100A for creating a beverage formulation. In particular, FIG. 1A illustrates the social profile 105 of user John Doe 110 on an online social beverage formulation application 115 such as Salesforce's “Beverage Formulator.” In some implementations, the social profile 105 can be hosted on various social networking sites such as Chatter, Facebook, Twitter, etc. The social profile 105 can include the user's name, contact information, professional information, and/or picture. The beverage formulation application 115 can include a virtual beverage container 117 in the shape of a bottle, cup, can or the like. It can also include various buttons, widgets or screen objects 116, 118, 120, 121, 122, 124, and 125 representing different beverage flavors such as Vanilla Coke, Cherry Coke, Orange Coke, etc. FIG. 1A also shows user-input 114 and save button 124. In other implementations, user-interface 100A may not have the same screen objects or as those listed above and/or may have other/different screen objects instead of, or in addition to, those listed above.

The graphical user-interfaces 100A-D can provide an interface or dashboard for the first user 215 to interact with the beverage formulation application 115, including creating beverage formulations 135 and 154. The graphical user-interfaces 100A-D can take one of a number of forms, including dashboard interfaces, engagement consoles, and other interfaces, such as a mobile interfaces or summary interfaces.

In some implementations, the online social beverage formulation application 115 can be a web-based or cloud-based application running on any computing device such as a personal computer, laptop computer, mobile device or any other hand-held computing device. It can also be a non-social local application running in an on-premise environment. In some implementations, the online social beverage formulation application 115 can be accessed from a browser 105 running on a computing device. The browser 105 can be Chrome, Internet Explorer, Firefox, Safari, etc.

In another implementation, the beverage formulation application 115 as an engagement console can be computer desktop application primarily used for multi-user content engagement. The engagement console can present buttons 116, 118, 120, 121, 122, 124, and 125 into configurable “stacks” such that users can create new beverage formulations or modify existing beverage formulations through individual posts. These stacks can also support various filters and execution of workflow macros allowing customers to assign rules and triggers to the beverage formulations. For instance, users can specify which flavors may not be added due to medical conditions or other taste reasons.

Regarding the graphical user-interfaces 100A, it shows the beginning phase of the beverage formulation. It includes an empty virtual beverage container 117 and various buttons 116, 118, 120, 121, 122, 124, and 125 representing various beverage flavors. It further shows the first user 215 making a selection of beverage flavor 116 via user-input 114.

FIG. 1B shows another implementation of a graphical user-interface 100B for creating a beverage formulation. The beverage formulation application 115 can include various widgets 130, 131, 132, 133, 134, 137, and 141 such as Sprite with Cherry, Sprite with Strawberry, Sprite with Grape, Sprite with Peach, etc. FIG. 1B also includes widgets 136 and 138 that illustrate the beverages selected by the user for formulation via user-input 142. FIG. 1B shows virtual pourings 126 and 127 of the selected beverages in the container 117. In other implementations, user-interface 100B may not have the same screen objects or as those listed above and/or may have other/different screen objects instead of, or in addition to, those listed above.

When the first user 215 makes a selection of beverage flavors 136 and 138, the virtual beverage container 117 can be streamed with the selected flavors 136 and 138 to create beverage formulation 135 that includes virtual pourings 126 and 127. The beverage formulation application 115 can then generate a beverage identity token 153 such as a quick response (QR) code that represents the beverage mix 154 formulated by the first user 215 along with its ingredient beverage flavors 126, 127 and 128. As explained later in this application, this beverage identity token 153 can be used by the first user 215 to dispense the corresponding real-world drink from a beverage dispensing machine 205. In some implementations, the beverage formulation application 115 can ask the first user 215 to assign a name or title to the newly customized beverage or formulation 154 such as “Diet Coke Berry Bliss.” In other implementations, it can ask the first user 215 to either cancel or save the formulated beverage mix 154.

FIG. 1C illustrates another implementation of a graphical user-interface 100B for creating a beverage formulation. The beverage formulation application 115 can include various widgets 143, 144, 146, 148, 149, and 151 such as Fanta Raspberry, Fanta Cherry, Fanta Peach, Fanta Grape, etc. FIG. 1C also includes widgets 147, 136 and 138 that illustrate the beverages selected by the user for formulation. FIG. 1C also shows virtual pourings 126, 127 and 128 of the selected beverages in the container 117. Screen dashboard 152 displays the name assigned by the user to the newly created beverage formulation. It also includes an optical interface barcode 153 representing the newly created formulation 154. In other implementations, user-interface 100C may not have the same screen objects or as those listed above and/or may have other/different screen objects instead of, or in addition to, those listed above.

When the first user 215 makes a selection of beverage flavor 147, the virtual beverage container 117 can be streamed with the selected flavor 147 to create beverage formulation 154 that includes virtual pourings 126, 127 and 128.

FIG. 1D shows another implementation of a graphical user-interface 100D for creating a beverage formulation. The beverage formulation application 115 can summarize the formulated beverage 154 and its ingredients 136, 138 and 147 along with a greeting message 156. In other implementations, user-interface 100D may not have the same screen objects as those listed above and/or may have other/different screen objects instead of, or in addition to, those listed above.

FIG. 1D shows a summary of the user operations previously performed on interfaces 100A-C along with a greeting message 156. In some implementations, it can show a summary of the user-customized beverage formulation 154 along with its virtual pourings 126, 127 and 128 and ingredient beverage flavors 147, 136 and 138.

### Beverage Formulation Environment

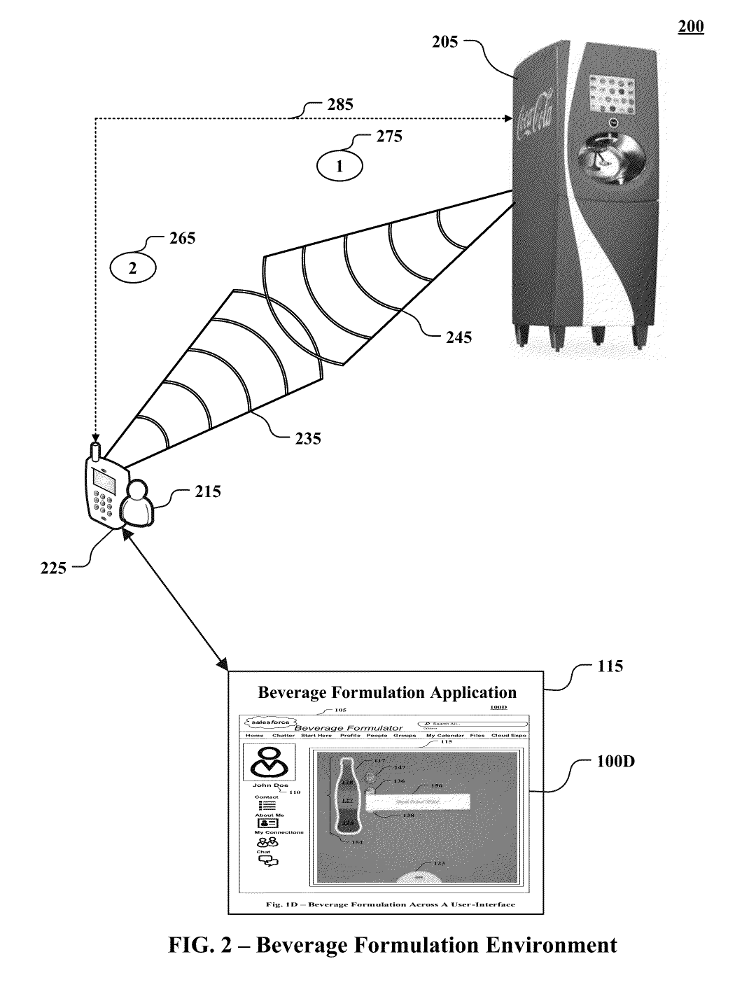

FIG. 2 shows one implementation of a beverage formulation environment 200. The beverage formulation environment 200 can include a dispensing machine 205, mobile device 225 carried by first user 215, beverage identity tokens 265 and 275 that are transmitted over RF signal 285, and beverage formulation application 115. In other implementations, beverage formulation environment 200 may not have the same elements or as those listed above and/or may have other/different elements instead of, or in addition to, those listed above.

The dispensing machine 205 can be any beverage vending machine or device capable of dispensing beverages including Coke Freestyle, Pepsi Fusion, Bunn-O-Matic, IMI Cornelius, Inc., Curtis, Black and Decker, and Cecilware or other traditional beverage dispensing machines. The mobile device 225 can be any cellphone device or hand-held computing device such as a tablet computer, personal digital computer (PDA), music player, etc.

The dispensing machine 205 and device 225 can include a number of components, the controlling components being processors. Processors can include one or more digital signal processor (DSP), microprocessor, microcontroller, central procession unit (CPU) or graphics processing unit (GPU), application specific integrated circuit (ASIC), reduced instruction set computing (RISC) or field-programmable gate array (FPGA) or a combination of these processor types. Processors can control the overall operations of the dispensing machine 205 and device 225. In addition to their operating system functions, they can execute software applications on the dispensing machine 205 and device 225. The processors can interact with other components of the respective dispensing machine 205 and device 225 such as radio frequency (RF) transceivers, device interfaces, memory units, etc.

The dispensing machine 205 and device 225 when co-located at a geographic location can broadcast and receive beverage identity tokens 265 and 275. These tokens can be exchanged through various communication channels such as peer-to-peer connections, cellular networks, common wireless local area network access points, and/or user inputs across a user interface. These tokens can be further stored in the memory units of the dispensing machine 205 and device 225.

The beverage identity tokens 265 and 275 can be a snippet or chunk of data that can represent user-customized beverages or formulations and can be broadcasted by a device or machine to other devices and machines which are within the transmission range of the broadcasting device. In some implementations, beverage identity tokens 265 and 275 can be cryptographic keys generated by one or more ciphers running on the broadcasting device. Some examples of ciphers can include block ciphers, stream ciphers, symmetric key algorithms (e.g., triple-DES, AES), etc.

In some implementations, the beverage identity tokens can be a single dimensional (1D) barcode such as universal product code (UPC) or a two dimensional (2D) barcode like quick response (QR) code. In other implementations, beverage identity tokens 265 and 275 can be series of characters, unique identifiers, keys, or machine-readable strings that can be entered into the dispensing machine 205 across a user-interface.

The mobile device 225 can encode a beverage identity token 275 that is a machine-readable representation of the user-customized beverage or formulation. The beverage identity token 275 is adapted to be sent to and acted upon by a beverage dispensing machine. In some implementations, beverage identity token 275 can cause the beverage dispensing machine 205 to dispense the user-customized beverage or formulation in a container. In other implementations, the online social beverage formulation application 115 can forward an electronic form of the beverage token 275 to other users in social networks of a first user 215 who customized the beverage formulation. This can result in the others users receiving the beverage formulation customized by the first user 215 and further allowing them to dispense the same beverage from the dispensing machine 205 as the one formulated by the first user 215.

In some implementations, the user-customized beverage formulation can be created on a device different then the mobile device 225 such as personal, laptop or tablet computer and then the corresponding beverage identity token can be transferred to the mobile device 225. This can provide a tablet experience to the first user 215 during beverage formulation and a hand-held experience during token transfer. In some implementations, a beverage can be formulated by a second user of the beverage formulation application 115 and the corresponding beverage identity token can be forwarded to the first user 215 for beverage dispensing.

The beverage dispensing machine 205 can communicate with users through the beverage identity token 265. In some implementations, the dispensing machine 205 can include greetings, bonus points for purchases, information about beverage formulations, sale offers, etc. in the beverage identity token 265. In other implementations, the dispensing machine 205 can share the user-customized beverage formulation with other users in social networks of a first user 215 by forwarding the beverage identity token 265 that represents or includes the user-customized beverage formulation to mobile device 225 or to a server in communication with the online social beverage formulation application 115.

For instance, when a first user 215 John Doe 110 creates a user-customized beverage formulation with the online social beverage formulation application 115, the beverage identity token holding the user-customized beverage formulation can be shared on the social profile 105 of John Doe 110. In some implementations, other users in social networks of John Doe 110 can use the shared beverage identity token to further dispense the same corresponding drink from the beverage dispensing machine 205.

The dispensing machine 205 and device 225 can use Bluetooth technology to exchange beverage identity tokens 265 and 275 by including data payloads in the respective discovery beacons 235 and 245. In some implementations, the Bluetooth technology can include an identification phase and a pairing phase. During the identification phase, the dispensing machine 205 can set a frequency-hopping pattern, to which the device 225 can synchronize its signals. In the pairing phase, the dispensing machine 205 and device 225 can transmit low power short-range RF signals and broadcast beverage identity tokens 265 and 275. Alternatively, beverage identity tokens 265 and 275 can be received and processed without pairing in a connectionless mode.

In some implementations, the beverage dispensing machine 205 and mobile device 225 can use near field communication (NFC) for ultra-short-range communication and replace the identification phase of the Bluetooth technology with a simple tap between the dispensing machine 205 and device 225. In case of NFC, the dispensing machine 205 and mobile device 225 can include antennas that function as windings of a transformer to generate high power ultra-short-range RF signals for broadcasting beverage identity tokens 1 and 2. In other implementations, a radio frequency identifier (RFID) or NFC identifier can be included in the beverage identity token 275, which is transmitted by the mobile device 225 to the beverage dispensing machine 205. The RFID or NFC identifier can be received or read by an RFID or NFC reader integrated in the dispensing machine 205.

In some implementations, the beverage dispensing machine 205 and device 225 can participate in wireless local area network (WLAN) through Wi-Fi, via an access point that broadcasts a Wi-Fi signal usable over a medium-range area. In response to a media access control (MAC) address based address resolution protocol (ARP) scan initiated by beverage dispensing machine 205 and device 225, the AP can generate a list of devices connected to it along with their MAC address, names, format, Internet Protocol (IP), etc.

In some implementations, the beverage formulation application 115 can generate the beverage identity token 275 in the form of a barcode such as quick response (QR) code. The QR code can be stored in the mobile device 225 in an electronic form and/or further printed/labeled/affixed. The QR code then can be scanned on a RFID reader or scanner appended to the dispensing machine 205. In other implementations, the QR code can be a scan-able URL directing to a website or webpage address including information about the user-customized beverage formulation.

The location information of mobile device 225 and beverage dispensing machine 205 can be used to estimate likely proximity between them. In some implementations, a location data transceiver and a network adapter, coupled to a respective processors running on the mobile device 225 and beverage dispensing machine 205, can generate the corresponding location data. In some implementations, this location data can be calculated using real-time GPS or GNSS reporting.

In some implementations, when the mobile device 225 is within the transmission range of the beverage dispensing machine 205, a physical proximity event can be automatically created and stored in the memory unit of mobile device 225. The creation of the physical proximity event can trigger when the location of mobile device 225 matches the location of the beverage dispensing machine 205. In other implementations, it can be created upon initiation of peer-to-peer communication between of mobile device 225 and beverage dispensing machine 205.

In some implementations, when a physical proximity event is created, the beverage formulation application 115 can generate a “preferred mix list” of beverage formulations based on user preferences. This “preferred mix list” can specify the beverage formulations pre-assigned or selected by a first user 215. Examples of user preferences can include: beverage formulations shared on online social networks by other users in social networks of the first user 215, particular beverage formulations specified by the first user 215, most frequently created beverage formulations of the first user 215, most recently created beverage formulations of the first user 215, most popular beverage formulations in one or more groups identified by the first user 215, and beverage formulations liked on social networks by the first user 215. The use of beverage formulations based on user preferences is further explained in the following section.

### Beverage Formulation Schema

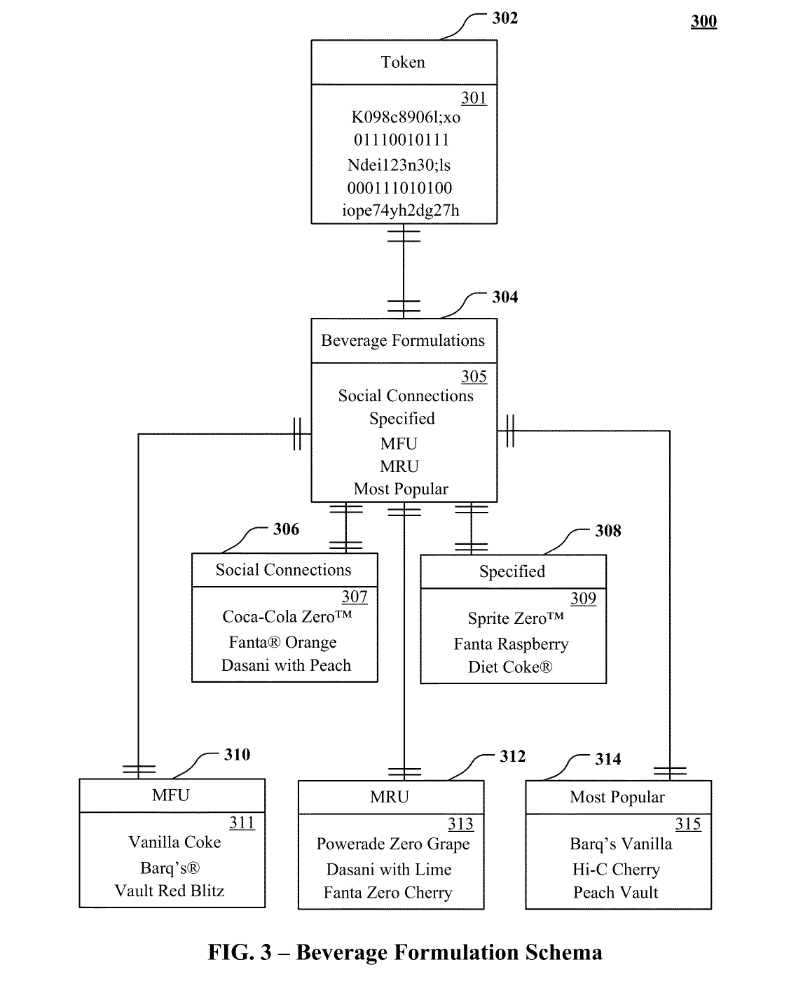

FIG. 3 illustrates one implementation of a beverage formulation schema 300. FIG. 3 shows that schema 300 can include a beverage formulations table 304. In some implementations, beverage formulations table 304 can be associated with a social connections table 306, specified table 308, most frequently used (MFU) table 310, most recently used (MRU) table 312, and most popular table 310. The beverage formulations table 304 can be further associated with a unique identifiers table 302. In other implementations, schema 300 may not have the same tables or fields as those listed above and/or may have other/different tables or fields instead of, or in addition to, those listed above. For instance, beverage formulations table 304 can be associated with a ‘liked’ table that include beverages formulations liked or appreciated by the first user 215 in the social feed of social websites such as Chatter, Facebook, Twitter, etc.

When a “preferred mix list” of beverage formulations is generated based on user preferences, the corresponding beverage formulations table can be accessed to identify the particular beverage mix desired by the first user 215. In some implementations, the first user 215 can be asked to update his preferences after customization of beverage formulations by selecting various screen objects across a user interface.

In some implementations, a beverage formulations table 304 can represent user preferences related to beverage formulations. In some implementations, the beverage formulations table 304 can include fields 305 such as social connections, specified, most frequently used, most recently used, most popular, etc. These fields can be populated when a first user 215 specifies or assigns his or her beverage formulation preferences across a user interface.

The beverage formulations table 304 can be associated with a “social connections” table 306. The social connections table 306 can include beverage formulations shared on online social networks by other users in social networks of the first user 215. For example, the social connections table 306 can include beverage formulations like Coca-Cola Zero™, Fanta® Orange and Dasani with Peach shared on different social networking websites like Facebook, Twitter, Linkedin, etc. In other implementations, the first user 215 can receive notifications when other users share beverage formulations on the social networks or social groups of the first user 215. The first user 215 can then be asked to specify whether he desires to add the shared beverage formulations 307 to his preferences.

In some implementations, the beverage formulations table 304 can be associated with a “specified” table 308 The specified table 308 can include beverage formulations previously used or selected by the first user 215. For example, when the first user 215 selects a beverage formulation like Sprite Zero™, Fanta Raspberry, Diet Coke®, the specified table 308 can be updated to include the selected beverage formulations 309.

The beverage formulations table 304 can also be associated with a “most frequently used (MFU)” table 310. The MFU table 310 can include beverage formulations most often customized or selected by the first user 215. For example, if the first user 215 selects beverage formulations like Vanilla Coke, Barq's® and Vault Red Blitz more often than others, then these beverage formulations 311 can be added to the most frequently used (MFU) table 310.

In some implementations, the beverage formulations table 304 can further be associated with a “most recently used (MRU)” table 312. The MRU table 310 can include beverage formulations most recently used by the first user 215. For example, if the last three beverage formulations selected by the first user 215 are Powerade Zero Grape, Dasani with Lime and Fanta Zero Cherry, then the MRU table 310 is populated to include these beverage formulations 313.

The beverage formulations table 304 can also be associated with a “most popular” table 314. The most popular table 314 can include beverage formulations that are most popular amongst networks or groups specified by the first user 215. Examples of groups can include social groups of beverage vendors such as Facebook group of Coca Cola®. In some implementations, the first user 215 can receive notifications of the most popular beverage formulations on his pre-assigned social networks or social group. The first user 215 can then be asked to specify whether he desires to add the most popular beverage formulations 315 like to Barq's Vanilla, Hi-C Cherry and Peach Vault to his preferences.

### Flowcharts

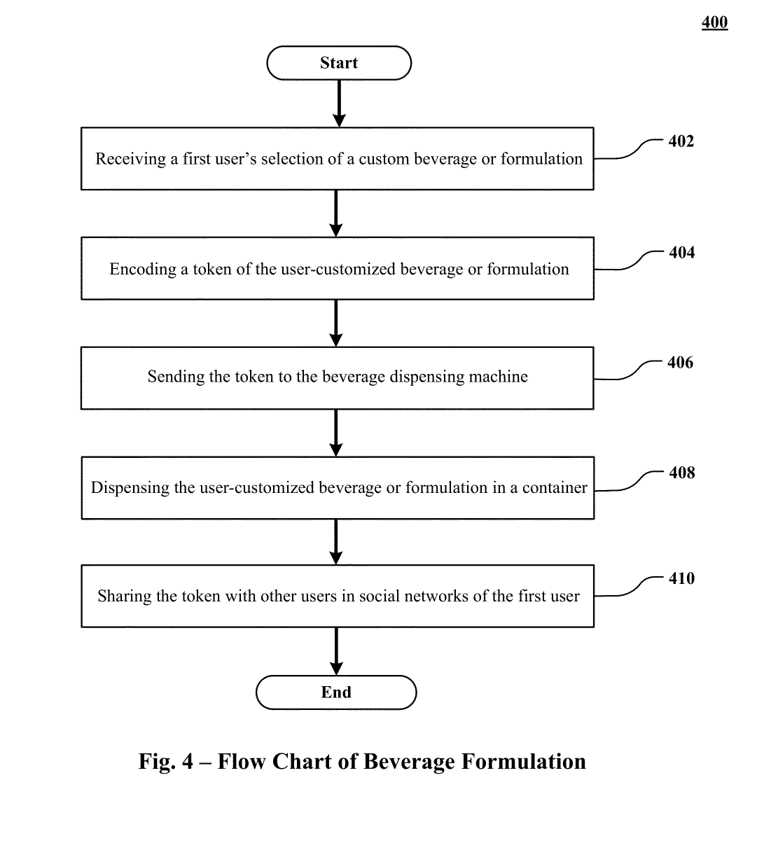

FIG. 4 is a flow chart 400 of one implementation of beverage formulation 100A-D. Other implementations may perform the steps in different orders and/or with different, fewer or additional steps than the ones illustrated in FIG. 4. Multiple steps can be combined in some implementations. For convenience, this flowchart is described with reference to the system that carries out a method. The system is not necessarily part of the method.

At step 402, a first user's selection of a custom beverage or formulation is received. In some implementations, user selection of the custom beverage or formulation can be received via the beverage formulation application 115 across a user-interface as described in “User-Interface” section of this application. In other implementations, user selection can be received as an audio input.

The beverage identity tokens for the user-customized beverage or formulation can be encoded at step 404. In some implementations, the user-customized beverage or formulation can be transformed into a machine-readable representation like cryptographic keys, universal product codes (UPC), quick response (QR) codes, series of characters, unique identifiers, or machine-readable strings as described in the “Beverage Formulation Environment” section of this application.

At step 406, the beverage identifier token can be sent to a beverage dispensing machine. In some implementations, the beverage identifier token can be transferred over various communication channels such as peer-to-peer connections, cellular networks, common wireless local area network access points, and/or user inputs across a user interface as described in the “Beverage Formulation Environment” section of this application.

After receiving the beverage identity token, the beverage dispensing machine can decode the token and identify the ingredient beverage flavors of the beverage formulation selected by the user. Then at step 408, the dispensing beverage machine can then dispense or inject the corresponding mix of beverage flavors in a container such as a cup, can or bottle.

At step 410, the beverage identity token holding the user-customized beverage formulation can be shared with other users in social networks of the first user as described in the “Beverage Formulation Environment” section of this application. The beverage identity token can be further used by the other users to dispense the same corresponding beverage from the beverage dispensing machine as the one formulated by the first user.

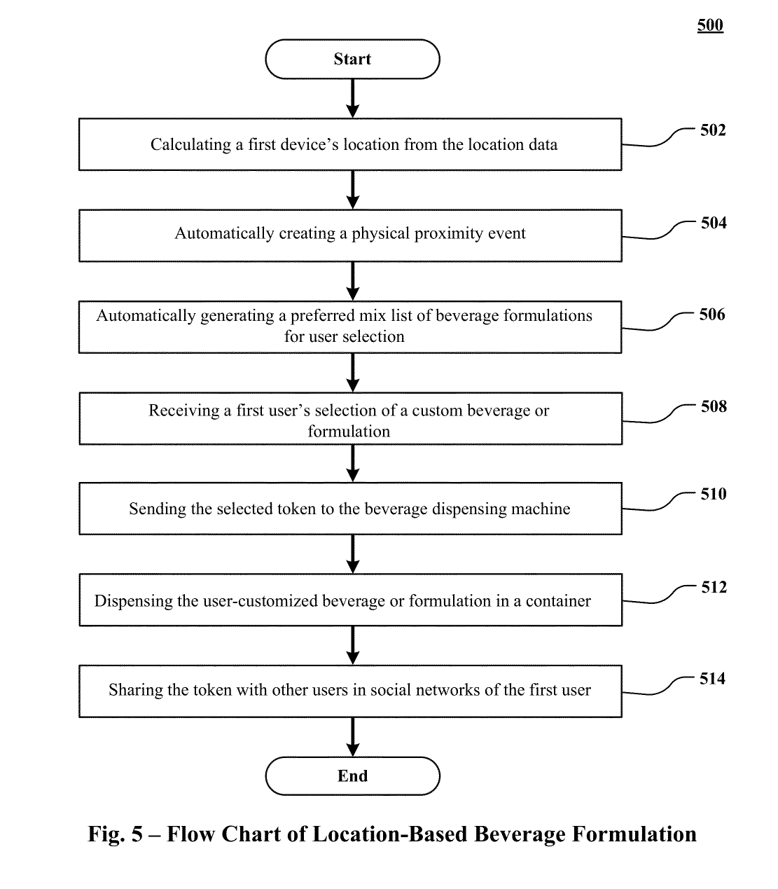

FIG. 5 is a flow chart 500 of one implementation of beverage formulation 100A-D. Other implementations may perform the steps in different orders and/or with different, fewer or additional steps than the ones illustrated in FIG. 5. Multiple steps can be combined in some implementations. For convenience, this flowchart is described with reference to the system that carries out a method. The system is not necessarily part of the method.

At step 502, the location information of a first device can be calculated through a location data transceiver and a network adapter coupled to respective processors running on the first device as described in the “Beverage Formulation Environment” section of this application. In some implementations, this location data can be calculated using real-time GPS or GNSS reporting.

At step 504, when the first device is within the transmission range of the beverage dispensing machine, a physical proximity event can be automatically created and stored in the memory unit of the first device as described in the “Beverage Formulation Environment” section of this application. The creation of the physical proximity event can trigger when the location of the first device matches the location of the beverage dispensing machine. In other implementations, it can be created upon initiation of peer-to-peer communication between of the first device and beverage dispensing machine.

When a physical proximity event is created, the beverage formulation application 115 can generate a “preferred mix list” of beverage formulations based on user preferences at step 506 as described in the “Beverage Formulation Environment” section of this application. This “preferred mix list” can specify the beverage formulations pre-assigned or selected by a first user.

At step 508, a first user's selection of a custom beverage or formulation is received. In some implementations, user selection of the custom beverage or formulation can be received via the beverage formulation application 115 across a user-interface as described in “User-Interface” section of this application. In other implementations, user selection can be received as an audio input.

At step 510, the beverage identifier token can be sent to a beverage dispensing machine. In some implementations, the beverage identifier token can be transferred over various communication channels such as peer-to-peer connections, cellular networks, common wireless local area network access points, and/or user inputs across a user interface as described in the “Beverage Formulation Environment” section of this application.

After receiving the beverage identity token, the beverage dispensing machine can decode the token and identify the ingredient beverage flavors of the beverage formulation selected by the user. Then at step 512, the dispensing beverage machine can then dispense or inject the corresponding mix of beverage flavors in a container such as a cup, can or bottle.

At step 514, the beverage identity token holding the user-customized beverage formulation can be shared with other users in social networks of the first user as described in the “Beverage Formulation Environment” section of this application. The beverage identity token can be further used by other users to dispense the same corresponding beverage from the beverage dispensing machine as the one formulated by the first user.

### Particular Implementations

In one implementation, a system is described for creating custom beverage formulations that includes at least one processor and code stored in memory coupled to the processor, which when executed on a processor receives a first user's selection of a custom beverage or formulation that mixes two or more beverages, encodes a beverage identity token of the user-customized beverage or formulation, wherein the beverage identity token is adapted to be sent to and acted upon by a beverage dispensing machine, and sends the beverage identity token to the beverage dispensing machine, whereby the beverage identity token causes the beverage dispensing machine to dispense the user-customized beverage or formulation in a container.

This system and other implementations of the technology disclosed can each optionally include one or more of the following features and/or features described in connection with additional systems disclosed. In the interest of conciseness, the combinations of features disclosed in this application are not individually enumerated and are not repeated with each base set of features. The reader will understand how features identified in this section can readily be combined with sets of base features identified as implementations such as user-interface, beverage formulation environment, beverage formulation schema, etc.

The system can further include a network interface coupled to the processor, wherein the code is further configured to cause the processor to use an optical interface that sends the beverage identity token to the beverage dispensing machine. It can also include a network interface coupled to the processor, wherein the code is further configured to cause the processor to use a radio frequency signal that sends the beverage identity token to the beverage dispensing machine.

The system can further include a network interface coupled to the processor, wherein the code is further configured to cause the processor to share the beverage identity token with other users in social networks of the first user. It can also include a network interface coupled to the processor, wherein the code is further configured to cause the processor to provide the beverage identity token to the beverage dispensing machine via peer-to-peer communication channels, cellular networks, common wireless local area network access points, and/or user inputs across a user interface.

The system can further include a network interface coupled to the processor, wherein the code is further configured to cause the processor to receive a beverage identity token of a customized beverage or formulation from other users and provide the beverage identity token to the beverage dispensing machine via the first user. It can also include a network interface coupled to the processor, wherein the code is further configured to cause the processor to create a customized beverage or formulation on a first device and encode the beverage identity token and forward the beverage identity token to a second device in a form adapted to be sent to the beverage dispensing machine.

Other implementations may include a non-transitory computer readable storage medium storing instructions executable by a processor to constitute a system as described above. Yet another implementation may include a method performed by the system as described above.

In another implementation, a system is described for improving sales of beverages that includes at least one processor and code stored in memory coupled to the processor, which when executed on a processor calculates a first device's location from the location data, automatically creates a physical proximity event stored in memory that represents likely proximity between the first device and a beverage dispensing machine when the device approaches the beverage dispensing machine, automatically generates a preferred mix list of beverage formulations for user selection, receives a first user's selection of a custom beverage or formulation and accesses a selected beverage identity token corresponding to the user selection and sends the selected beverage identity token to the beverage dispensing machine, whereby the beverage identity token causes the beverage dispensing machine to dispense the user-customized beverage or formulation in a container.

This system and other implementations of the technology disclosed can each optionally include one or more of the following features and/or features described in connection with additional systems disclosed.

The system can further include a network interface coupled to the processor, wherein the code is further configured to cause the processor to generate the preferred mix list of beverage formulations based on user preferences. It can also include a network interface coupled to the processor, wherein the code is further configured to cause the processor to calculate the first device's location using real-time GPS or GNSS reporting.

The system can further include a network interface coupled to the processor, wherein the code is further configured to cause the processor to trigger creation of the physical proximity event when the first device's location matches the dispensing machine's location. It can also include a network interface coupled to the processor, wherein the code is further configured to cause the processor to trigger creation of the physical proximity event upon initiation of peer-to-peer communication between the first device and the beverage dispensing machine.

Other implementations may include a non-transitory computer readable storage medium storing instructions executable by a processor to constitute a system as described above. Yet another implementation may include a method performed by the system as described above.

While the present invention is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

1. A method for creating custom beverage formulations, the method including:
receiving a first user's selection of a custom beverage or formulation that mixes two or more beverages;
encoding a beverage identity token of the user-customized beverage or formulation, wherein the beverage identity token is adapted to be sent to and acted upon by a beverage dispensing machine; and
sending the beverage identity token to the beverage dispensing machine, whereby the beverage identity token causes the beverage dispensing machine to dispense the user-customized beverage or formulation in a container.

2. The method of claim 1, further including using an optical interface that sends the beverage identity token to the beverage dispensing machine.

3. The method of claim 1, further including using a radio frequency signal that sends the beverage identity token to the beverage dispensing machine.

4. The method of claim 1, further including sharing the beverage identity token with other users in social networks of the first user.

5. The method of claim 1, further including providing the beverage identity token to the beverage dispensing machine via peer-to-peer communication channels, cellular networks, common wireless local area network access points, and/or user inputs across a user interface.

6. The method of claim 1, further including assigning a name or title to customized beverage or formulation.

7. The method of claim 1, further including
receiving a beverage identity token of customized beverage or formulation from other users; and
providing the beverage identity token to the beverage dispensing machine via the first user.

8. The method of claim 1, further including
creating a customized beverage or formulation on a first device and encode the beverage identity token; and
forwarding the beverage identity token to a second device in a form adapted to be sent to the beverage dispensing machine.

9. A method for improving sales of beverages, the method including:
calculating a first device's location from the location data;
automatically creating a physical proximity event stored in memory that represents likely proximity between the first device and a beverage dispensing machine when the device approaches the beverage dispensing machine;
automatically generating a preferred mix list of beverage formulations for user selection;
receiving a first user's selection of a custom beverage or formulation and accesses a selected beverage identity token corresponding to the user selection; and
sending the selected beverage identity token to the beverage dispensing machine, whereby the beverage identity token causes the beverage dispensing machine to dispense the user-customized beverage or formulation in a container.

10. The method of claim 9, further including generating the preferred mix list of beverage formulations based on user preferences.

11. The method of claim 9, further including calculating the first device's location using real-time GPS or GNSS reporting.

12. The method of claim 11, further including triggering creation of the physical proximity event when the first device's location matches the dispensing machine's location.

13. The method of claim 9, further including triggering creation of the physical proximity event upon initiation of peer-to-peer communication between the first device and the beverage dispensing machine.

14. A system for creating custom beverage formulations, the system including:
at least one processor;
code stored in memory coupled to the processor, which when executed on a processor:
receives a first user's selection of a custom beverage or formulation that mixes two or more beverages;
encodes a beverage identity token of the user-customized beverage or formulation, wherein the beverage identity token is adapted to be sent to and acted upon by a beverage dispensing machine; and
sends the beverage identity token to the beverage dispensing machine, whereby the beverage identity token causes the beverage dispensing machine to dispense the user-customized beverage or formulation in a container.

15. The system of claim 14, including a network interface coupled to the processor, wherein the code is further configured to cause the processor to use an optical interface that sends the beverage identity token to the beverage dispensing machine.

16. The system of claim 14, including a network interface coupled to the processor, wherein the code is further configured to cause the processor to use a radio frequency signal that sends the beverage identity token to the beverage dispensing machine.

17. The system of claim 14, including a network interface coupled to the processor, wherein the code is further configured to cause the processor to share the beverage identity token with other users in social networks of the first user.

18. The system of claim 14, including a network interface coupled to the processor, wherein the code is further configured to cause the processor to provide the beverage identity token to the beverage dispensing machine via peer-to-peer communication channels, cellular networks, common wireless local area network access points, and/or user inputs across a user interface.

19. The system of claim 14, including a network interface coupled to the processor, wherein the code is further configured to cause the processor to assign a name or title to customized beverage or formulation.

20. The system of claim 14, including a network interface coupled to the processor, wherein the code is further configured to cause the processor to
